(19) United States
(12) Patent Application Publication
(10) Pub. No.: US 2003/0034902 A1
(43) Pub. Date: Feb. 20, 2003

(54) Automatic pilot control system (ACS) for GLOC and ILOC, with aircraft following systems

(76) Inventor: John Eugene Dickau, Edmonton (CA)

Correspondence Address: JOHN DICKAU, #1108, 9837 - 110 STREET, EDMONTON, AB, T5K 2L8, CA

(21) Appl. No.: 10/216,389

(22) Filed: Aug. 12, 2002

Related U.S. Application Data
(60) Provisional application No. 60/312,760, filed on Aug. 17, 2001.

(51) Int. Cl. G08B 21/00

(52) U.S. Cl. 340/945; 340/963; 340/669; 701/11; 701/14

(57) ABSTRACT

This invention describes a automatic pilot control system (ACS) that activates the automatic pilot, if the pilot does not respond to a gravity induced loss of consciousness (GLOC) alarm, or a injury induced loss of consciousness alarm (ILOC). If the pilot does not respond to audible and/or visible alarms, the automatic pilot control system (ACS), has a indication that the pilot is not in control of the aircraft, and the ACS activates the automatic pilot. The injured pilot (ILOC) alarm is activated when the aircraft has been damaged. The GLOC alarm is activated after a high acceleration (G) turn. The ACS may receive input about the physiological status of the pilot.

If the automatic pilot is unable to maintain stable flight and a ground impact is imminent, the ACS activates a visible and audible ejection (E) alarm. The pilot must respond to the E alarm, or the ACS activates the ejection seat.

The ACS may establish a communications link with pilots in the flight group, or on the ground. Another pilot in the flight group can instruct the automatic pilot of the aircraft with the unconscious or injured pilot to follow his aircraft to safety.

The ACS can provide medical treatment, or establish a communications link with a medical doctor, or medic, to assist the pilot in recovery from GLOC, or treat the pilots injuries.

### CROSS REFERENCE TO RELATED APPLICATIONS

This application claims the priority benefit of U.S. Provisional Application No. 60/312,760 filed on Aug. 17, 2001.

### FEDERALLY SPONSORED RESEARCH

Not Applicable

### SEQUENCE LISTING OR PROGRAM

Not Applicable

### FIELD OF INVENTION

The present invention relates to systems to prevent crashing high-performance fighter aircraft after the pilot has suffered from GLOC (gravity induced loss of consciousness), or ILOC (injury induced loss of consciousness). After a high G event, or aircraft damage, or malfunction, a alarm sounds and the pilot must assert control otherwise an automatic pilot takes control of the aircraft. The invention has a automatic pilot ejection system that is activated if the automatic pilot cannot fly the plane and a ground impact is imminent. This invention further includes an automatic pilot that can assist pilot recovery from GLOC, fly evasive maneuvers, follow a preprogrammed safest egress flight path, communicate with another pilot of the flight group, or communicate with a ground based pilot.

This invention describes a medical assistance system that may be automatic, or may open a communications link to a ground based medical doctor. The medical assistance system assists the pilots recovery from GLOC, or treats a injured pilot. Drugs may be administered by oral, nasal or intravenous lines. Saline or whole blood may be administered by a intravenous line.

A modified G suit, and continued inflation of a G suit, to reduce GLOC recovery time and stop bleeding by acting as a tourniquet is described. The G suit is applied to the arms to restrict blood flow into the arms during high G maneuvers and in the case of a injury to the arms.

“Following systems” are described where another aircraft, or pilot, in a flight group can lead the aircraft with the injured pilot to safety. These following systems are based on transmitted way points, radar, infrared and optical tracking systems. These following systems can be used by unmanned aerial vehicles (UAV's).

### BACKGROUND TO THE INVENTION

A pilot can lose consciousness and control of the aircraft due to gravity induced loss of consciousness (GLOC), or injury induced loss of consciousness (ILOC).

The acceleration generated by a fighter aircraft is measured in G's, or multiples of the force of gravity. Gravity is a acceleration of 9.8 m/s2 or 32 ft/s2. Pilots can tolerate positive accelerations of approximately nine times gravity. These high gravity conditions reduce blood flow to the brain. Without a constant blood flow to the brain the pilot loses consciousness. This is termed “gravity induced loss of consciousness” or GLOC.

Pilots can tolerate approximately nine positive gravity's before blacking out. Pilots can tolerate approximately three negative gravity's before experiencing red out. Tolerance to G forces varies from individual to individual.

Various systems have been described, and developed, to increase the multiples of gravity, or G's, a pilot can withstand. These include gravity, or G suits, tilting seats, and breathing techniques.

Ground avoidance systems prevent the aircraft from flying into the ground. Pilots have complained that these ground avoidance systems limit their ability to maneuver near the ground, and could result in loss of the aircraft due to ground fire, or attacking aircraft, or missiles.

Therefore, there is a need in the art for an automatic pilot control system which is able to determine whether or not a pilot has lost consciousness and is able to control the aircraft if the pilot is unconscious. It may be advantageous if the system incorporated a communications link, a medical assistance system and/or a “following” system which interact with the control system.

### SUMMARY OF THE INVENTION

This invention comprises a device that senses acceleration when a high performance fighter aircraft turns. This acceleration is referred to in multiples of gravity (G's), or multiples of 9.8 m/s2 or 32 ft/s2. When the acceleration produced by turning of the aircraft exceeds a given value for a given time, in a given direction, a light and audible G alarm is activated. The pilot must either move a switch, or make a voice command, within a set time after the G alarm activation, or the automatic pilot takes over operation of the aircraft, establishing a flight pattern that does not intersect the ground. If the pilot does not move the switch, or make a voice command, the automatic pilot control system (ACS) has a indication that the high G event has caused the pilot to suffer from gravity induced loss of consciousness (GLOC).

The ACS also has sensor inputs that indicate if the aircraft has suffered battle damage, or lost functions. A visible and audible injured pilot alarm is activated when the aircraft has been damaged. The pilot must either move a switch, or give a voice command, within a set time after the injured pilot alarm activation, or the automatic pilot takes over operation of aircraft, establishing a flight pattern that does not intersect the ground. If the pilot does not move the switch, or give the voice command or otherwise assert control, within a time period after the E alarm activation, the automatic pilot control system (ACS) has a indication that the battle damage sustained by the aircraft, has caused the pilot to suffer from injury induced loss of consciousness (ILOC).

If the automatic pilot is unable to maintain a stable flight pattern and a ground impact is imminent, as determined by a ground avoidance system, the ACS activates a visible and audible ejection (E) alarm. The pilot must either move a switch, or give a voice command, within a time period after the E alarm activation, or the ejection seat is activated, and the pilot is ejected from the aircraft.

The ACS may establish a communications link with other pilots in the flight group. Another pilot in the flight group can determine whether the other pilot has suffered from GLOC, or ILOC. The other pilot can instruct the automatic pilot of the aircraft with the unconscious pilot to follow his aircraft to safety. The ACS may establish a communications link with a ground pilot that can fly the aircraft.

The ACS can provide medical treatment, or establish a communications link with a medical doctor, or medic, to assist the pilot in recovery from GLOC, or treat the pilots injuries.

### BREIF DESCRIPTION OF THE FIGURES

FIG. 1 Automatic pilot control system for GLOC or ILOC with a pilot ejection system and medical support, and a communications link to another pilot, a ground pilot, or medical doctor.

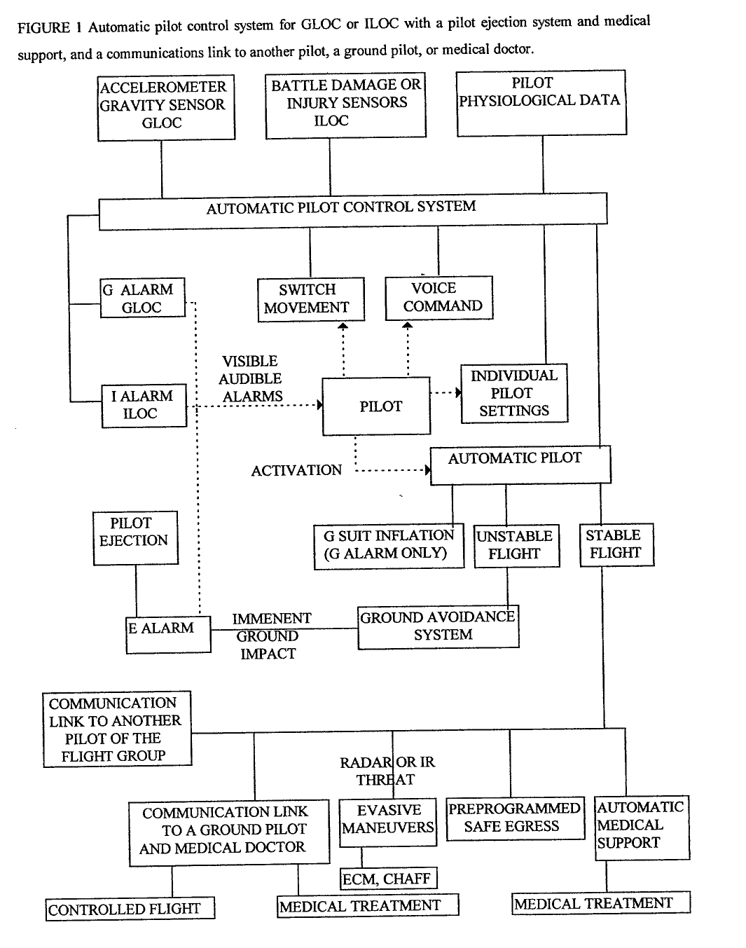

FIG. 2 Pilot medical support

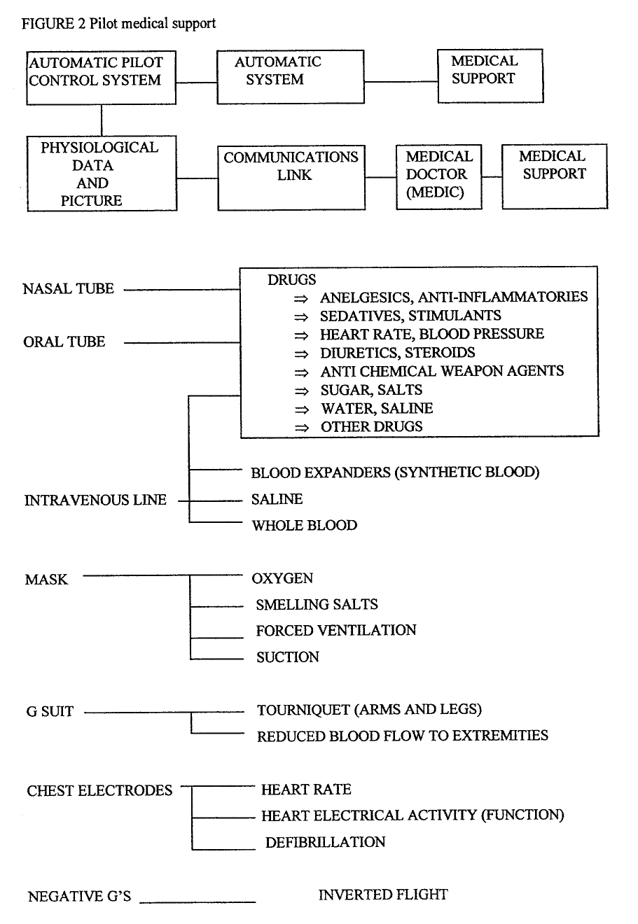

### DETAILED DESCRIPTION OF THE INVENTION

1. Autopilot, Ground Avoidance and Pilot Ejection Systems

This invention comprises a accelerometer that detects the acceleration generated when a high performance fighter aircraft turns. The accelerometer transmits the level of the G force, the duration of the G force, and the direction of the G force to the auto pilot control system (ACS). The accelerometer detects positive, or negative, G's developed by flight maneuvers. The auto pilot control system is set to a profile of G forces, duration's and directions that the individual pilot has a rating for. Alternatively, the auto pilot control system may have a standard profile of G forces, duration's, and directions for that particular aircraft. When the individual pilots rating profile, or the aircraft's standard profile, of G forces, duration's and directions is exceeded the auto pilot control system activates a “G” alarm.

The individual pilots rating profile of G forces, duration's and directions can be modified by the pilot. If the pilot wishes to reduce his rating profile on a particular day he may do so. If the pilot feels ill, or is not flying well, he may set the auto pilot control system to activate the G alarm at lower G forces, duration's and directions. The pilot may reduce his or her G force and duration rating by a percentage of his or her maximal rating, or alternatively, reduce the aircraft's standard profile.

The automatic pilot control system “G” alarm is a distinctive visible light, of a particular color that may flash, or a distinctive audible alarm, or both a visible and audible alarm. The pilot must respond to this “G” alarm by moving a switch, or making a voice command within a pre-determined time period which may be several seconds. The pilots response to the “G” alarm indicates that he is conscious and in control of the aircraft. If the pilot does not respond within a time period after the “G” alarm activation, the automatic pilot control system has the indication that the pilot has suffered from gravity induced loss of consciousness (GLOC), and the automatic pilot control system takes over control of the aircraft.

The pilots vocal command may be a word such as “okay” or “right” which requires minimal voice recognition systems. The voice recognition, or vocal command system does not require physical movement from the pilot. The pilot can continue maneuvering the aircraft without being distracted by having to move a switch.

The pilots individual G force, duration and direction rating profile is not the maximum values that the pilot can tolerate before experiencing gravity induced loss of consciousness (GLOC). The pilots individual G force and duration rating profile is a percentage of the pilots maximum tolerance. At times the pilots physiology, or a unusual maneuver, may result in the pilot suffering from gravity induced loss of consciousness, at lower G forces and duration's than the pilots maximum tolerance levels. The pilot's maximum tolerance to G forces and duration's may be established in a centrifuge. These centrifuge testing values may relate to flight conditions, but are not actual flight conditions. Safety is increased by having the automatic pilot control system activate the “G” alarm well below the pilots maximum tolerance levels.

If the pilot does not respond to the automatic pilot control system “G” alarm the auto pilot takes control of the aircraft and establishes a flight path that does not intersect the ground. Radar, Global Positioning System, altimeter, and ground avoidance system information (all of which are well known in the art) can be used by the automatic pilot control system to establish a safe flight path.

The time available for the pilot to respond to the “G” alarm can be shortened to allow high G maneuvers near the ground. The automatic pilot control system can quickly take control of the aircraft after a high G event has caused the pilot to experience gravity induced loss consciousness. The ACS may have a automatic function that shortens the time period that the pilot has to respond to the G alarm, depending on how close the aircraft is to the ground.

Ground avoidance systems currently used can take control of the aircraft and prevent the aircraft from crashing. Pilots have indicated that these systems can limit their evasive maneuvers near the ground resulting in the aircraft being damaged by ground fire, or a pursuing aircraft, or missile. The ground avoidance systems currently used take over aircraft operation even if a high G event has not occurred, and it would be expected that the pilot has control of the aircraft. This invention may be used with a ground avoidance system that is activated only after a high G maneuver has occurred, and the pilot has not responded to the “G” alarm.

In one embodiment of the invention, the ground avoidance system can not activate the automatic pilot unless the pilot has experienced a high G event.

This invention may include an aircraft flight control system that limits the G's that a aircraft can generate. The G forces developed by aircraft maneuvering can be limited to maintain the aircraft's structural integrity, or to prevent the pilot from experiencing gravity induced loss of consciousness. The pilot may still suffer GLOC even when flying a G force limited aircraft. The G force limited aircraft has a automatic pilot control system (ACS) with a “G” alarm that the pilot must respond to, or the automatic pilot is activated.

The automatic pilot control system can be programmed to fly evasive maneuvers (including activating electronic counter measures, dazzlers and releasing flares and/or chaff) and/or fly a preprogrammed safest egress flight path that avoids ground threats, such as surface to air missiles (SAM's). Using communications systems the automatic pilot control system may allow another pilot at a ground station to fly the aircraft to safety, or fly the aircraft until the pilot has regained consciousness. The communications system can be used by a ground pilot to fly the aircraft away from enemy aircraft, visible on radar, or away from recently identified SAM sites, or update the safest egress flight path program. The ground pilot can receive current information about the mechanical condition and performance of the aircraft, and the reason the ACS communication link was activated.

The ACS may establish a communications link with other pilots in the flight group. Another pilot in the flight group can determine whether the other pilot has suffered from GLOC, or ILOC. A lead aircraft pilot can instruct the automatic pilot of the aircraft, with the unconscious pilot, to activate “following systems”. The automatic pilot “following system” of the aircraft with the injured pilot may establish a radar, infrared, laser or optical (visual) lock on the lead pilots aircraft. A optical (visual) lock may not function at night. Alternatively, the lead aircraft may continually send a updated set of way points, arrival times and aircraft speeds to the automatic pilot of the aircraft with the injured pilot. The way points provided by the leading aircraft would be a slight offset of the flight path of the leading aircraft. These “following systems” could be used during normal flight operations to allow a single pilot in the flight group to control all aircraft in the flight group. The other pilots could then manage other aspects of the mission, or conserve energy and concentration for the mission. These “following systems” could be used for very close proximity flying techniques which may confuse enemy radar, or could be used for flight formations that reduce fuel consumption. These following systems could be applied to UAV's that carry additional weapons for use by the lead pilot.

The lead pilot has access to the automatic pilot control system ejection seat function of the following aircraft. The lead pilot may eject a unconscious pilot from a severely damaged aircraft that is going to crash.

The automatic pilot control system may include a battle damage sensing system where if the aircraft sustains damage, or loss of function, the pilot must respond to a automatic pilot control system pilot injury (I) alarm. If the pilot does not respond by moving a switch, or making a voice command, within a time period after the injury alarm activation, the automatic pilot control system has an indication that the pilot has been injured, and the automatic pilot control system takes over flight of the aircraft. The ‘I’ alarm is visibly and audibly different from the “G” alarm.

If the automatic pilot is unable to establish stable flight due to battle damage and the ground avoidance system indicates that a ground impact is imminent, a ejection (E) alarm that is visually and audibly different from the “I” and ‘T’ alarms is activated. The pilot must respond by moving a switch, or making a vocal command, within a time period of the “E” alarm activation, or the ejection seat is activated, and pilot is ejected from the aircraft. The injured or unconscious pilot may survive a parachute landing, but would not survive a crash while within the aircraft.

The automatic pilot ejection system may eject a injured pilot that activates a automatic pilot prior to losing consciousness, and the automatic pilot cannot develop stable flight, and a ground impact is imminent. If the pilot does not respond to the ejection alarm by moving a switch, or making a vocal command, the pilot is ejected from the aircraft.

The “G”, ‘I’ and “E” alarms are preferentially different visually and/or audibly so as to be easily differentiated from each other by the pilot.

2. Physiological Data

The automatic pilot control system may also monitor physiological parameters of the pilot. These physiological parameters may be heart rate, blood pressure, respiratory rate and/or brain electrical activity. The pilot may have electrodes attached to his chest that record electrical activity and are connected to a cardiac defibrillator. Physiological parameters in themselves would not provide sufficient information for activation of the automatic pilot control system alarms. This is due to the variability of physiological data during air combat. The physiological data from the pilot may be used by the automatic pilot control system to further establish the need to activate the G, I, or E alarms.

Medical Assistance, Medical G Suit and G Suit Usage

The activation of the automatic pilot may cause the simultaneous opening of a communications link that allows a pilot at a ground location to operate the aircraft. This communications link may be used to relay the physiological data obtained from the pilot to a medical doctor, or medic, at a ground location. The communication systems may send a picture of the pilot, to the ground based pilot and medical doctor if an on-board camera is provided and activated. The pilot can activate the medical communications system during flight for any reason, without activating the automatic pilot, The pilot has control over the automatic pilot medical function and can activate medical assistance systems manually. The medical system can be customized to the pilot. Some pilot may have allergies to drugs and size differences between pilots affects drug dosages.

With the physiological information, and a picture of the pilot, a medical doctor may undertake to assist a unconscious pilots recovery from GLOC, or alternatively treat the pilots injuries. The ground pilot and medical doctor, or medic, can evaluate the pilots condition to determine if the pilot can continue the mission, or how quickly the pilot should be returned for medical treatment.

In assisting the pilot to recover from GLOC the administration of higher levels of oxygen may help. If the aircraft has a reclining seat the seat may be reclined. The pilot may recover from GLOC more rapidly if the aircraft is maneuvered to place the pilot in a slight negative g condition, such as inverted level flight, which aids blood flow to the pilots brain. Smelling salts, or ammonium nitrate capsules, could be broken in air lines leading to the pilots mask. If the pilot has a tube entering his nose, or mouth, drugs could be administered, adrenaline could be given to increase heart rate and blood pressure, and reduce blood flow to the extremities. The nasal, or oral, tube has a air flow that blows droplets of the drug into the nose or mouth. The drugs are absorbed through the oral mucosa or ingested. If the G suit worn by pilots is deflated when the aircraft is not subjected to high G forces, but the pilot is unconscious, the G suit is inflated to restrict blood flow to the lower body and extremities, thereby, increasing blood flow to the brain. The G suit function is modified so that it is inflated when the pilot does not respond to the “G” alarm and the automatic pilot is activated. If the aircraft has a positive pressure ventilation system the pilots rate of respiration may be increased to increase oxygen and carbon dioxide exchange rates. If there is vomit in the pilots mask a suction line to the pilots mask may be activated to clear the pilots mask and airway. Activation of inverted or positive G flight, the G suit, ventilation systems, increased oxygen flow, smelling salts, mask suction and drug administration may be controlled by the automatic pilot without establishing a communications link with a medical doctor, or in cases where a medical communications link cannot be established. The pilot can activate and customize the automatic pilot medical system by manual inputs.

The G suit can be used as a tourniquet to reduce bleeding of the legs or arms. A modified G suit has air bladders, within the suit, that encircle the upper arms and legs. The lower body G suit inflatable bladder concept is extended to the arms. These arm bladders are activated during high G maneuvers in unison with the activation of the lower body G suit. The restriction of blood flow into the arms may increase tolerance to G forces slightly, at times this slight increase in G force tolerance may be critical. When air bladders that encircle the arms and legs are activated they prevent blood from entering the arms and legs during high G maneuvers, and when activated for extended time periods prevent blood loss from a injured limb, by acting as tourniquets. Tourniquets close off blood flow for a time period then allow blood flow during a second time period. In this modified G suit each limb encircling air bladder is controlled individually, and a limb may have one encircling air bladder near the torso and another along the limb, in addition to air bladders acting on the major muscle groups. The G suit may have blood sensors located through out the suit. These blood sensors could be electrical resistors that have a altered resistance when contacted by blood. The encircling air bladder on a bleeding limb can be activated by the medical doctor, the automatic pilot, or the pilot.

A variety of drugs may be administered through nose, or mouth tubes. The pilot may be hooked to a intravenous line during the mission. The IV line could be used to supply saline, blood expander, synthetic blood, or the pilots own whole blood, taken weeks prior to the mission. A variety of drugs could be administered to the GLOC, or injured pilot through a IV line.

Analgesics, sedatives, stimulants, heart rate and blood pressure regulating drugs, vasoconstrictors, adrenaline, morphine, sugar, salts, atropine, anti-chemical warfare agents and other drugs could be administered by mouth tube, nose tube, or IV line.

Those skilled in the art will readily appreciate that many modifications, substitutions or alterations can be effected to the arrangement of the present invention without departing from the scope of the present invention.

I claim:

1) A Automatic Pilot Control System (ACS) to prevent the loss of a aircraft when the pilot experiences gravity induced loss of consciousness (GLOC) consisting of
a) a means, such as a accelerometer, that detects acceleration, or g forces, experienced by the aircraft and pilot,
b) a electronic control system that activates a visual, and/or audible, “G” alarm when the g forces detected exceed a maximum value,
c) a means to detects the pilot has recognized the “G” alarm
d) a automatic pilot that is activated if the pilot does not recognize the “I” alarm.

2) The ACS in claim 1 where the means to detect the pilots recognition of the G alarm is the pilot moving, or throwing, a switch

3) The ACS in claim 1 where the means to detect the pilots recognition of the G alarm is the pilot making a vocalization that is recognized by a voice recognition system.

4) The ACS in claim 1 where if aspects of the pilot activity indicate the pilot is conscious the “G” alarm is not activated.

5) The ACS in claim 4 where the aspects of the pilots activity examined are physiological, anatomical or behavioral.

6) The ACS in claim 1 where the G suit remains functional to resist blood flow into the pilots extremities until the pilot responds to the G alarm.

7) A Automatic Pilot Control System (ACS) to prevent loss of a aircraft and pilot consisting of
a) a system that detects damage to the aircraft
b) a electronic control system that activates a visual, and/or audible “I” alarm when damage to the aircraft is detected,
c) a means to detect that the pilot has recognized the “I” alarm
d) a automatic pilot that is activated if the pilot does not recognize the “I” alarm.

8) The ACS in claim 7 where the means to detect the pilots recognition of the I alarm is the pilot moving, or throwing, a switch.

9) The ACS in claim 7 where the means to detect the pilots recognition of the I alarm is the pilot making a vocalization that is recognized by a voice recognition system.

10) The ACS in claim 7 where if aspects of the pilot activity indicate the pilot is conscious the “I” alarm is not activated.

11) A ACS system in claim 7 where if the automatic pilot cannot establish stable flight of a damaged aircraft with a injured pilot, and ground impact is imminent, a “E” alarm is activated, that the pilot must respond to or the pilot is ejected from the aircraft.

12) A ACS system that can establish communication with other flight group pilots, or ground stationed pilots or medical personal.

13) The ACS in claim 12 where the communication link provides the automatic pilot with input to fly a aircraft with a injured, or unconscious pilot.

14) The ACS in claim 12 where a video camera image of the pilot is transmitted to other pilots in the flight group, or ground stationed pilot or medical personnel.

15) A ACS in claim 12 in which mechanical performance of the aircraft is transmitted to other pilots in the flight group, or to a ground station pilot.

16) A ACS that is pre-programmed to fly a safest egress route when activated.

17) A ACS with a “following system” that allows a aircraft with a active ACS system, to follow another aircraft in a flight group.

18) The ACS in claim 17 where the pilot activates automatic pilot following systems, allowing his aircraft to follow another aircraft, while that pilot undertakes mission management tasks.

19) The ACS in claim 17 where the following systems are active in a unmanned air vehicle.

20) The ACS in claim 17 where the following systems use infrared, radar, or optical sensors, or way point transmission methods to follow the lead aircraft.

21) A ACS which can provide medical support to a pilot autonomously or by establishing a communications link to medical personnel.
